(19) United States
(12) Patent Application Publication
(10) Pub. No.: US 2003/0087146 A1
(43) Pub. Date: May 8, 2003

(54) Battery cover plate having a safety valve

(76) Inventor: Ming-Chun Chi, Chang-Hua City (TW)

Correspondence Address: Merchant & Gould P.C., P.O. Box 2903, Minneapolis, MN, 55402-0903, US

(21) Appl. No.: 10/005,954

(22) Filed: Nov. 8, 2001

(51) Int. Cl. H01M 2/04; H01M 2/12

(52) U.S. Cl. 429/56; 429/82; 429/175

(57) ABSTRACT

A battery cover plate includes upper and lower metal substrates, and a safety valve. The lower metal substrate is opposite to the upper metal substrate, and has an anti-explosion hole that is aligned with an anti-explosion hole in the upper metal substrate. The safety valve can release excessive pressure present inside a battery, and includes a metal foil that is capable of bursting when the pressure inside the battery exceeds a preset burst pressure value. The metal foil is sandwiched between the upper and lower metal substrates, and seals the anti-explosion holes in the upper and lower metal substrates.

### BACKGROUND OF THE INVENTION

1. Field of the Invention

The invention relates to a battery cover plate, more particularly to a battery cover plate having a safety valve that can prevent a battery from exploding.

2. Description of the Related Art

Owing to a trend to miniaturization and weight reduction of portable electronic devices, there is a big demand for mini-batteries and high capacity batteries used for these devices. To meet such a demand, a lithium battery has been developed. A typical lithium battery includes a positive electrode (composed of lithium ion, a metal of particular group, and oxygen), a negative electrode (made from carbon), and a liquid electrolyte (an organic solvent containing a lithium salt). In such a battery, the abnormal pressure present inside the battery is prevented from rising and producing an explosion by mounting a safety valve on a battery cover plate to release the excessive pressure. Referring to FIGS. 1 and 2, a conventional battery cover plate 10 is shown to have a safety valve 100 mounted on a metal substrate 11. The metal substrate 11 is subjected to a cold press to form a groove 12 and press marks 121 at the bottom of the groove 12. The groove 12 and the press marks 121 cooperate to form the safety valve 100. When the pressure present inside the battery (not shown) exceeds a preset burst pressure value, the bottom of the groove 12 will burst at the press marks 121 to release the excessive pressure. However, due to the preciseness required in designing and forming the press marks 121, difficulties are encountered in producing the battery cover plate 10. The quality of the product can be unstable since the thickness of the press marks 121 cannot be kept uniform.

Another battery cover plate 20 has been developed to overcome the drawback encountered with the above conventional battery cover plate 10. Referring to FIG. 3, the battery cover plate 20 is provided with an orifice 21 and a receiving space 211. A safety membrane 22 is inserted into the receiving space 211, and covers the orifice 21 to form a safety valve. The safety membrane 22 is formed from a metal substrate 221 and a metal foil 223 welded to the bottom of the metal substrate 221. The metal substrate 221 is provided with an anti-explosion hole 222, while the metal foil 223 seals the anti-explosion hole 222. Furthermore, as shown in FIG. 4, an anti-explosion hole 31 is provided in yet another battery cover plate 30. A metal foil 32 is welded to the bottom of the cover plate 30 and seals the hole 31 to form a safety valve. Although each of the above mentioned battery cover plates 20, 30 has a safety valve designed for releasing excessive pressure inside the battery by bursting the metal foil 223, 32, there are some drawbacks in such cover plates 20, 30. Firstly, since the metal foils 223, 32 are very thin and are exposed at one side of the battery cover plates 20, 30, they are easily deformed, damaged, and scratched when they push against each other during production. Thus, the preset burst pressure value of the battery is affected. Secondly, since press rollers are used in coupling the metal foils 223, 32 with the metal substrate 221 and the cover plate 30, and since burrs are formed around the anti-explosion holes 222, 31 during a drilling process in the metal substrate 221 and the cover plate 30, the burrs may scratch and cut the metal foils 223, 32. As such, the metal foils 223, 32 can become thinner, deformed, or damaged, thereby affecting and changing the preset burst pressure value of the safety valve. This can cause the safety valve to become ineffective.

### SUMMARY OF THE INVENTION

Therefore, the main object of the present invention is to provide a battery cover plate having a safety valve that prevents effectively a battery from exploding.

Accordingly, a battery cover plate of the present invention is adapted for covering an open end of a lithium battery. The battery cover plate comprises an upper metal substrate, a lower metal substrate, and a safety valve. The upper metal substrate has an anti-explosion hole. The lower metal substrate is opposite to the upper metal substrate, and has an anti-explosion hole that is aligned with the hole in the upper metal substrate. The safety valve releases excessive pressure present inside the battery, and includes a metal foil that is capable of bursting when the pressure inside the battery exceeds a preset burst pressure value. The metal foil is sandwiched between the upper and lower metal substrates, and seals the anti-explosion holes in the upper and lower metal substrates.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional battery cover plate;

FIG. 2 is a schematic cross-sectional view of the battery cover plate of FIG. 1;

FIG. 3 is a perspective view of another conventional battery cover plate;

FIG. 4 is a perspective view of yet another conventional battery cover plate;

FIG. 5 is a perspective view of the preferred embodiment of a battery cover plate according to the present invention;

FIG. 6 is a schematic cross-sectional view of the battery cover plate of FIG. 5; and

FIG. 7 is a schematic cross-sectional view illustrating how the battery cover plate of FIG. 5 is fabricated.

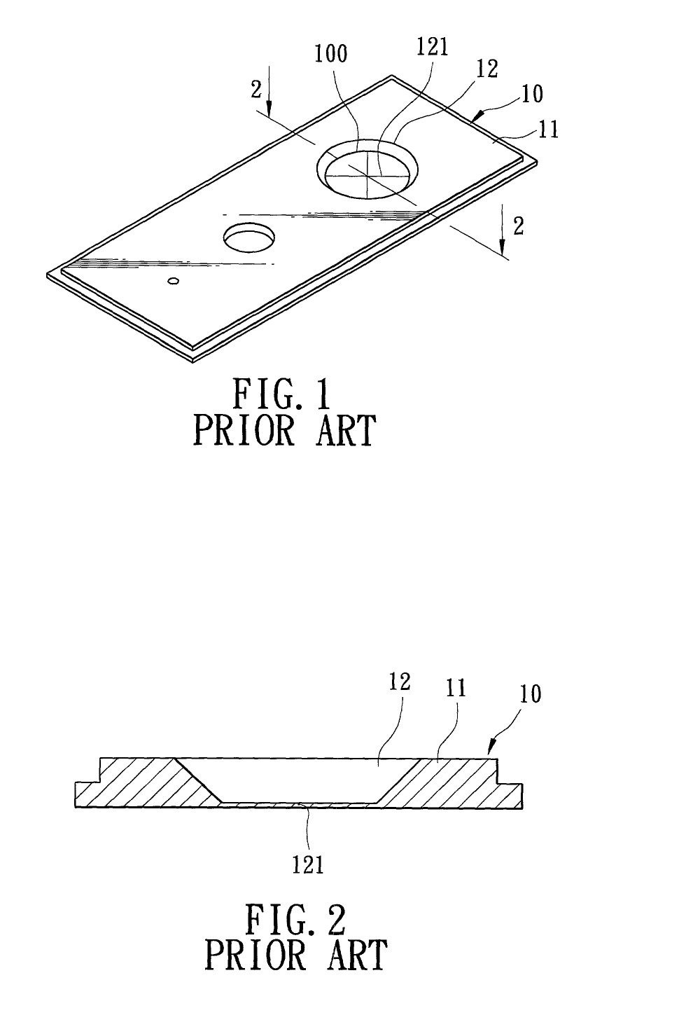

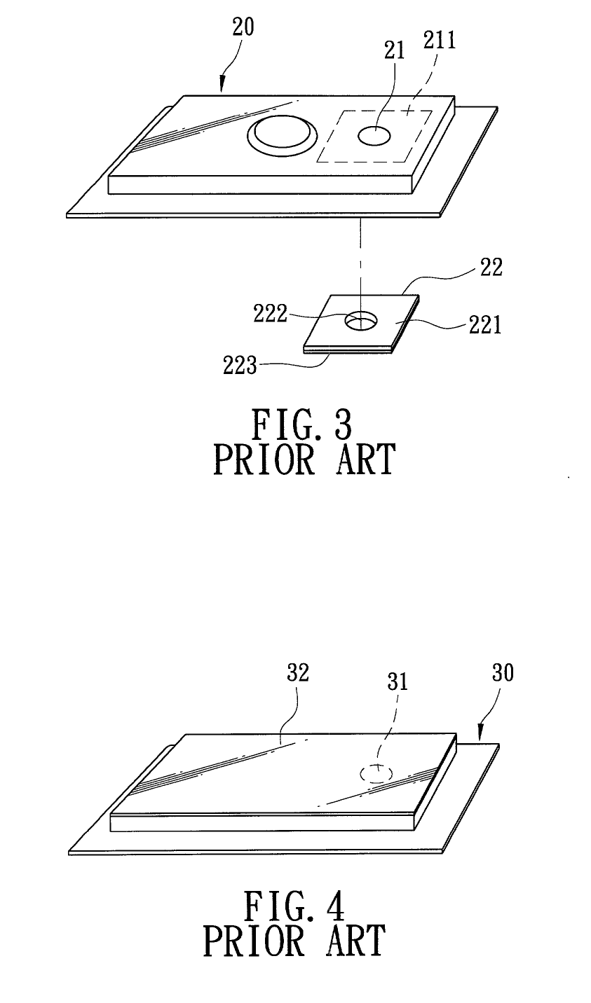

### DETAILED DESCRIPTION OF THE PREFERRED EMBODIMENT

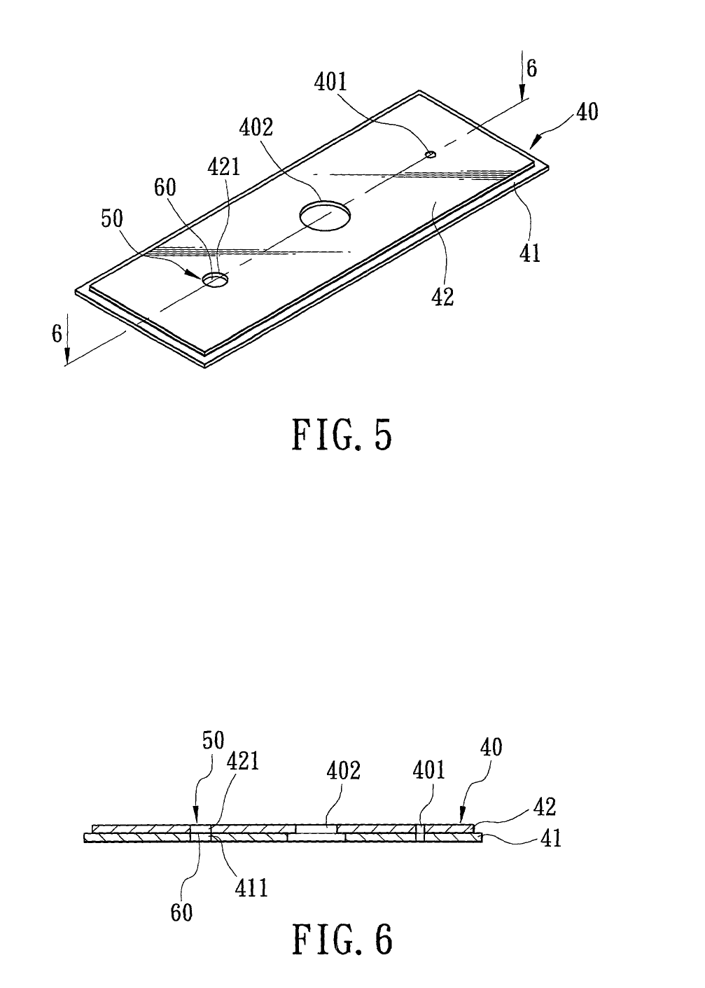

Referring to FIGS. 5 and 6, the preferred embodiment of a battery cover plate 40 according to the present invention used to cover an open end of a lithium battery (not shown) is shown. The battery cover plate 40 comprises an upper metal substrate 41, a lower metal substrate 42, and a safety valve 50. The upper metal substrate 41 has an anti-explosion hole 411. The lower metal substrate 42 is opposite to the upper metal substrate 41, and has an anti-explosion hole 421 that is aligned with the hole 411 in the upper metal substrate 41. Numerals 401, 402 respectively represent an injection hole and an electrode hole. In this embodiment, the upper and lower metal substrates 41, 42 are made from a metal plate selected from the group consisting of a steel plate, a copper plate, and an aluminum plate, and are provided with an appropriate thickness as required.

The safety valve 50 can release excessive pressure present inside the battery, and includes a metal foil 60 that is capable of bursting when the pressure inside the battery exceeds a preset burst pressure value. The metal foil 60 is sandwiched between the upper and lower metal substrates 41, 42, and seals the anti-explosion holes 411, 421 in the upper and lower metal substrates 41, 42. In this embodiment, the metal foil 60 is made of a metal selected from the group consisting of steel, aluminum, nickel, and a Ni-Fe alloy.

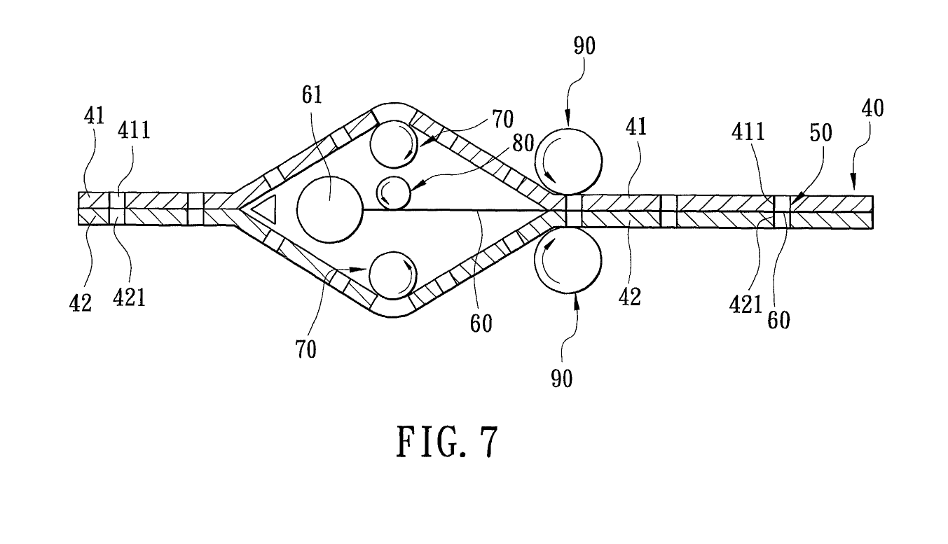

FIG. 7 illustrates the process of inserting the metal foil 60 between the upper and lower metal substrates 41, 42. Initially, two opposing rollers 70 are used to separate the upper and lower metal substrates 41, 42. The metal foil 60 is unwound from a roll 61 and is then guided by a heated roller 80 to force through the gap between the upper and lower metal substrates 41, 42. Finally, the press rollers 90 press together the upper metal substrate 41, the metal foil 60, and the lower metal substrate 42, which are then cut to form a plurality of battery cover plates 40 with predetermined dimensions. The metal foil 60 seals the anti-explosion holes 411, 421 to form the safety valve 50 at this time.

After the battery cover plate 40 covers an open end of the battery (not shown), the electrolyte is then injected into the battery through the injection hole 401. When the abnormal pressure inside the battery rises and reaches the preset burst pressure value, the metal foil 60 will burst to release the excessive pressure. Thus, the battery is prevented from exploding.

Since the battery cover plate 40 of the present invention has the metal foil 60 clamped between the upper and lower metal substrates 41, 42, the metal foil 60 is not easily damaged, deformed, or scratched during production. Furthermore, the press rollers 90 press the upper and lower metal substrates 41, 42 without directly acting on the metal foil 60. As such, the metal foil 60 is prevented from being deformed and damaged. Thus, the safety valve 50 can function effectively and accurately.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A battery cover plate for covering an open end of a lithium battery, comprising:
an upper metal substrate having an anti-explosion hole;
a lower metal substrate opposite to said upper metal substrate and having an anti-explosion hole aligned with said hole in said upper metal substrate; and
a safety valve for releasing excessive pressure present inside the battery and including a metal foil which is capable of bursting when the pressure inside the battery exceeds a preset burst pressure value, said metal foil being sandwiched between said upper and lower metal substrates and sealing said anti-explosion holes in said upper and lower metal substrates.

2. The battery cover plate of claim 1, wherein said upper and lower metal substrates are made from a metal plate selected from the group consisting of a steel plate, a copper plate, and an aluminum plate.

3. The battery cover plate of claim 1, wherein said metal foil is made of a metal selected from the group consisting of steel, aluminum, nickel, and a Ni-Fe alloy.
